(19) United States
(12) Patent Application Publication
(10) Pub. No.: US 2026/0319092 A1
(43) Pub. Date: Oct. 15, 2026

(54) OPTICAL NAVIGATION SENSOR AND RELATED OPTICAL NAVIGATION SYSTEM

(71) Applicant: PixArt Imaging Inc., Hsin-Chu City (TW)

(72) Inventor: Yu-Ju Lee, Hsin-Chu City (TW)

(73) Assignee: PixArt Imaging Inc., Hsin-Chu City (TW)

(21) Appl. No.: 19/176,199

(22) Filed: Apr. 11, 2025

(51) Int. Cl. G01S 17/58; G01S 17/93

(52) U.S. Cl. CPC G01S 17/58; G01S 17/93

(57) ABSTRACT

An optical navigation sensor is applied for an operation processor with a displacement synchronization function and includes a tracking module, a decoder, a readout buffer and an accumulated buffer. The tracking module is adapted to generate detection data. The decoder is adapted to receive a trigger event. The readout buffer is connected to the operation processor via a communication interface. The accumulated buffer is connected to the tracking module, the decoder and the readout buffer. The accumulated buffer is adapted to store the detection data from the tracking module, and further to immediately update the detection data to the readout buffer when the decoder receives the trigger event, so as to transmit the detection data from the readout buffer to the operation processor through the communication interface.

### BACKGROUND OF THE INVENTION

### 1. Field of the Invention

The present invention relates to an optical navigation sensor and a related optical navigation system, and more particularly, to an optical navigation sensor and a related optical navigation system with the displacement synchronization function.

### 2. Description of the Prior Art

Optical detection technology is widely used in various types of products. The common optical tracking device is applied to the mouse wheel for detecting the rotation and pressing of the wheel. With the advanced technology, the optical detection technology is further combined with the transportation tool for trajectory tracking operation. The size of the mouse wheel is relatively small, and one optical detection chip can effectively detect a movement of the wheel. The transportation tool has the large body; if the optical detection chip is only installed on one side of the transportation tool, the optical detection chip may easily misjudge the trajectory of the transportation tool during the turning path. Therefore, a plurality of optical detection chips is needed to install on different positions of the transportation tool for acquiring the correct trajectory. The plurality of optical detection chips may have different displacement references, which are difficult to be integrated together in the computation process. If some of the optical detection chips have abnormal detection results, the integration result of the optical detection chips is misled and affects the accuracy of the detection results. Therefore, design of an optical navigation system with a displacement synchronization function is an important issue in the related optical equipment industry.

### SUMMARY OF THE INVENTION

The present invention provides an optical navigation sensor and a related optical navigation system with the displacement synchronization function for solving above drawbacks.

According to the claimed invention, an optical navigation sensor is applied for an operation processor with a displacement synchronization function and includes a tracking module, a decoder, a readout buffer and an accumulated buffer. The tracking module is adapted to generate detection data. The decoder is adapted to receive a trigger event. The readout buffer is connected to the operation processor via a communication interface. The accumulated buffer is connected to the tracking module, the decoder and the readout buffer. The accumulated buffer is adapted to store the detection data from the tracking module, and further to immediately update the detection data to the readout buffer when the decoder receives the trigger event, so as to transmit the detection data from the readout buffer to the operation processor through the communication interface.

According to the claimed invention, an optical navigation system with a displacement synchronization function includes an operation processor, an communication interface and a plurality of optical navigation sensors. The operation processor is adapted to output a trigger event. The plurality of optical navigation sensors is electrically connected with the operation processor via the communication interface. Each of the plurality of optical navigation sensors includes a tracking module, a decoder, a readout buffer and an accumulated buffer. The tracking module is adapted to generate detection data. The decoder is adapted to receive the trigger event. The readout buffer is connected to the communication interface. The accumulated buffer is connected to the tracking module, the decoder and the readout buffer, and adapted to store the detection data from the tracking module. The plurality of optical navigation sensors is adapted to synchronously update the detection data from a plurality of accumulated buffers to corresponding readout buffers when the decoder receives the trigger event, so as to alternately transmit the detection data from the readout buffers to the operation processor through the communication interface.

According to the claimed invention, the operation processor is electrically connected with the plurality of optical navigation sensors via the one-to-many communication interface, or is electrically connected with the plurality of optical navigation sensors via the many-to-many communication interface.

According to the claimed invention, the detection data inside the accumulated buffer is deleted when the decoder receives the trigger event and the detection data is updated to the readout buffer; the detection data generated by the tracking module is accumulated and stored inside the accumulated buffer during a time period of the decoder not receiving the trigger event.

According to the claimed invention, the detection data is displacement data generated by the tracking module in object tracking process. The displacement data of the plurality of optical navigation sensors is integrated by the operation processor to synchronously process tracking trajectories respectively generated by the plurality of optical navigation sensors.

According to the claimed invention, the detection data is time duration or a frame count of all frames generated by the tracking module in object tracking process. The operation processor analyzes the time duration or the frame count of the plurality of optical navigation sensors to compensate a frame rate difference or a phase difference between the plurality of optical navigation sensors.

According to the claimed invention, the detection data is a tracking confidence level generated by the tracking module in object tracking process. The operation processor compares tracking confidence levels of the plurality of optical navigation sensors with a preset threshold range, and sets a weight ratio about the plurality of optical navigation sensors in accordance with a comparison result.

According to the claimed invention, the optical navigation sensor analyzes a feature matching result of several frames generated by the tracking module in the object tracking process for converting into the tracking confidence level; or, the optical navigation sensor analyzes a difference between a predicted trajectory and a tracking trajectory generated by the tracking module in the object tracking process for converting into the tracking confidence level.

The optical navigation system of the present invention can design the communication interface with specific definition among the operation processor and the optical navigation sensors. The communication interface may be the GPIO interface for transmitting the pulse signal or the I2C interface for transmitting the bus command. The optical navigation sensor can additionally include the decoder and the accumulated buffer; the accumulated buffer can store the detection data of the tracking module before synchronously updating process, and the decoder can receive the trigger event for synchronously updating the detection data from the accumulated buffer to the readout buffer. The detection data can include, but not be limited to, the displacement data, the time duration and/or the frame count of the frames, and the tracking confidence level. The present invention can synchronize the displacement data of the plurality of optical navigation sensors, and further compensate the displacement data by the time duration and/or the frame count of the frames and the tracking confidence level, so that the operation processor can calibrate the difference in the frame rate, the phase and the tracking confidence level among the plurality of optical navigation sensors, for providing the preferred displacement synchronization function.

In product application, the optical navigation system of the present invention can dispose the plurality of optical navigation sensors respectively on different positions of the transportation tool, such as the position near by a front wheel and a rear wheel on the left side of the vehicle, and the position near by the front wheel and the rear wheel on the right side of the vehicle. The plurality of optical navigation sensors can transmit the displacement data generated in the object tracking process to the operation processor, and the operation processor can integrate the displacement data via the foresaid displacement synchronization function, so as to accurately decide the behavior (such as moving forward, moving backward, and turning) of the vehicle; optionally, the time duration and/or the frame count of the frames and the tracking confidence level can be optionally applied to calibrate the synchronously integrated result of the displacement data and/or discard the abnormal frame, so the accuracy of the displacement synchronization function can be improved accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an optical navigation system according to an embodiment of the present invention.

FIG. 2 is a functional block diagram of an optical navigation sensor according to the embodiment of the present invention.

FIG. 3 and FIG. 4 are diagrams of connection among an operation processor and the optical navigation sensors according to different embodiments of the present invention.

FIG. 5 is an operation diagram of the optical navigation sensors according to the embodiment of the present invention.

### DETAILED DESCRIPTION

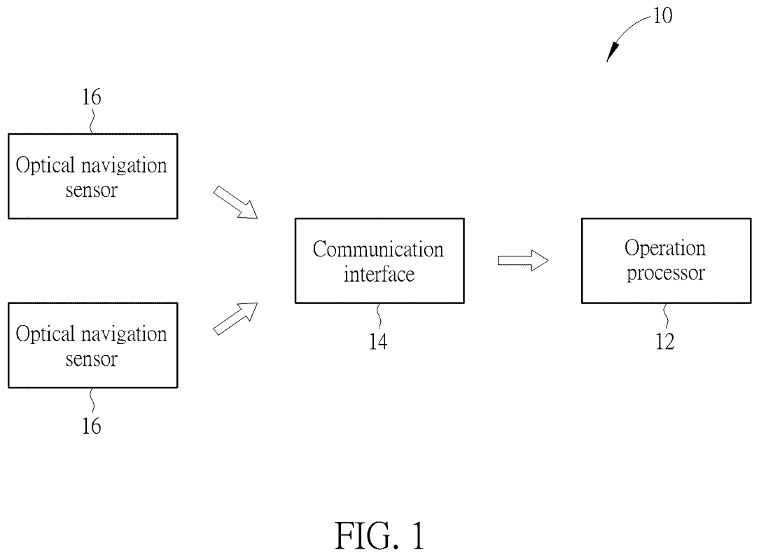

Please refer to FIG. 1. FIG. 1 is a functional block diagram of an optical navigation system 10 according to an embodiment of the present invention. The optical navigation system 10 can have a displacement synchronization function of optical multiple tracking technology, and can be applied for various types of transportation tools. For example, the optical navigation system 10 can be disposed on a bottom of the vehicle chassis, the robot vacuum or the unmanned aircraft, and detect feature points on the road or the ground to decide a movement of the vehicle, the robot vacuum or the unmanned aircraft. The optical navigation system 10 can be further disposed near by the treadmill track or the production line conveyor belt, and detect the feature points on the track or the conveyor belt to decide the movement. The optical navigation system 10 can include an operation processor 12, a communication interface 14 and an optical navigation sensor 16. A number of the optical navigation sensor 16 can be plural, and can be electrically connected with the operation processor 12 via the communication interface 14. The communication interface 14 can be the GPIO (general-purpose input/output) interface, or the I2C (inter-integrated circuit) interface, or the I3C (improved inter-integrated circuit) interface, or the SPI (serial peripheral interface) interface; application of the communication interface 14 is not limited to the foresaid embodiments, and depends on a design demand.

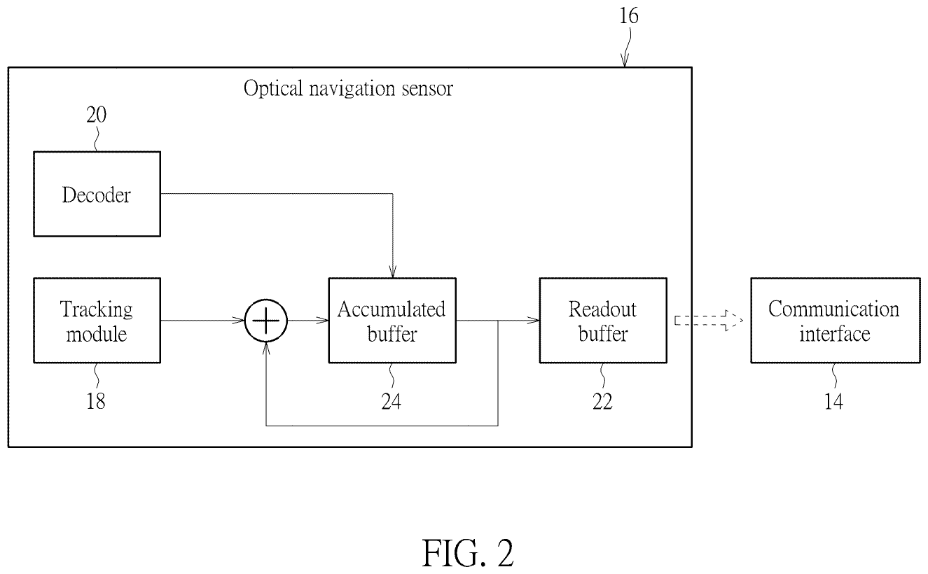

Please refer to FIG. 2. FIG. 2 is a functional block diagram of the optical navigation sensor 16 according to the embodiment of the present invention. The optical navigation sensor 16 can include a tracking module 18, a decoder 20, a readout buffer 22 and an accumulated buffer 24. The tracking module 18 can utilize trajectory tracking technology to acquire detection data. The detection data can be converted to determine a behavior (such as moving forward, moving backward, and turning) of the transportation tool where to the optical navigation system 10 is applied. The decoder 20 can receive and decode a trigger event output by the operation processor 12. The operation processor 12 can automatically output the trigger event due to a specific situation, or can manually output the trigger event when receiving a command provided by the user; application of the trigger event can depend on the design demand.

The readout buffer 22 can be connected to the communication interface 14. The accumulated buffer 24 can be disposed among the tracking module 18, the decoder 20 and the readout buffer 22, and used to store the detection data from the tracking module 18. When the optical navigation sensor 16 is operated, the tracking module 18 can generate the detection data continuously; during a time period of the optical navigation sensor 16 not receiving the trigger event, the detection data of the tracking module 18 can be accumulated and stored inside the accumulated buffer 24. When the plurality of optical navigation sensors 16 receives the trigger event output by the operation processor 12, each of the optical navigation sensors 16 can synchronously update the detection data from the accumulated buffer 24 to the readout buffer 22, and then the plurality of optical navigation sensors 16 can alternately transmit the detection data from the readout buffer 22 to the operation processor 12 through the communication interface 14; in the meantime, the detection data inside the accumulated buffer 24 can be deleted when the detection data is updated to the readout buffer 22.

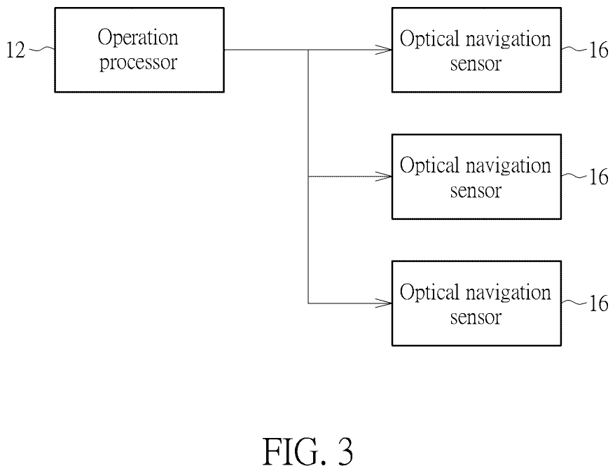

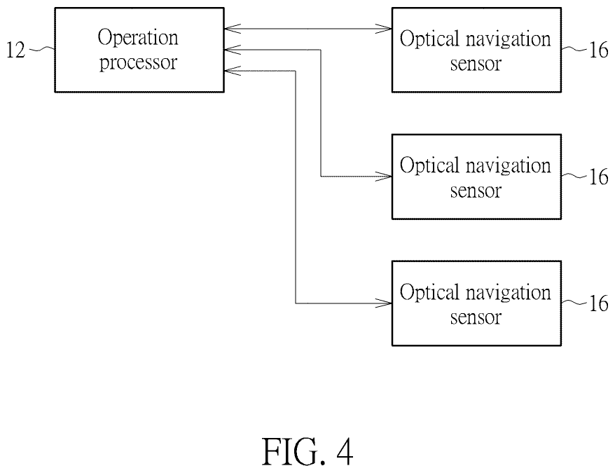

Please refer to FIG. 3 and FIG. 4. FIG. 3 and FIG. 4 are diagrams of connection among the operation processor 12 and the optical navigation sensors 16 according to different embodiments of the present invention. The optical navigation system 10 can design the communication interface 14 for transmission of the trigger event among the operation processor 12 and the optical navigation sensors 16. The trigger event may be defined as a pulse signal or a bus command in accordance with a type of the communication interface 14 (such as GPIO or I2C or I3C or SPI). In addition, the operation processor 12 may optionally utilize the one-to-many communication interface 14 (such as GPIO and I2C) to electrically connect with the plurality of optical navigation sensors 16, as shown in FIG. 3; or the operation processor 12 may optionally utilize the many-to-many communication interface 14 (such as SPI) to electrically connect with the plurality of optical navigation sensors 16, as shown in FIG. 4. Application of the type of the communication interface 14 can depend on the design demand.

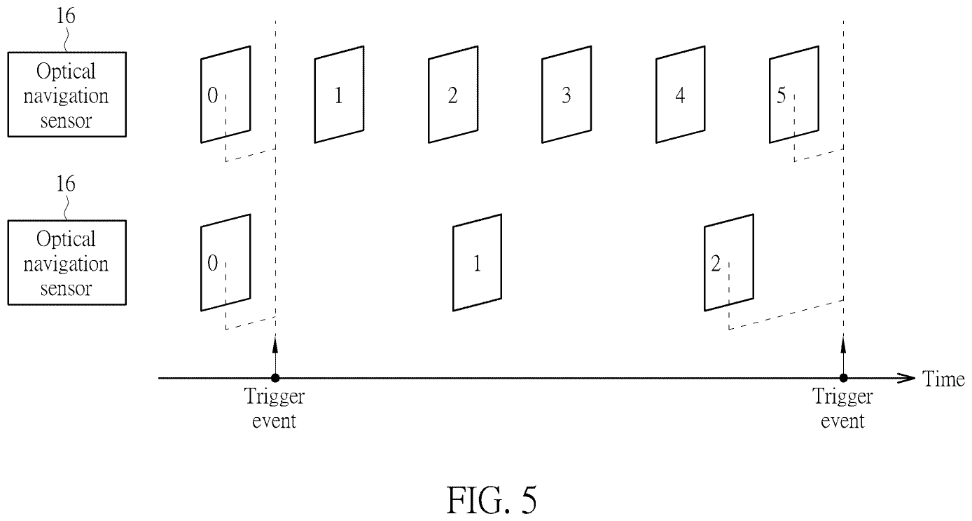

Please refer to FIG. 5. FIG. 5 is an operation diagram of the optical navigation sensors 16 according to the embodiment of the present invention. An example can be taken by at least two optical navigation sensors 16; as shown in FIG. 5, the upper optical navigation sensor 16 can have the higher frame rate, and the lower optical navigation sensor 16 can have the lower frame rate; if the optical navigation system 10 does not have the displacement synchronization function of the optical multiple tracking technology, the detection data of the upper optical navigation sensor 16 may be read every N frames (for example, N=5), and the detection data of the lower optical navigation sensor 16 may be read every M frames (for example, M=2). Due to the different frame rates, starting and ending points of the frames of different optical navigation sensors 16 may have errors and are difficult for integration.

In the preferred embodiment of the present invention, the detection data can include displacement data generated by the tracking module 18 in response to object tracking process, and the displacement data generated by the different optical navigation sensors 16 may have different starting and ending points. Therefore, the optical navigation system 10 of the present invention can provide the displacement synchronization function of the optical multiple tracking technology, and can drive each of the optical navigation sensors 16 to store the detection data generated by the tracking module 18 into the accumulated buffer 24, and then synchronously update the detection data to the readout buffer 22 when the decoder 20 receives the trigger event, for alternately transmitting the detection data from the readout buffer to the operation processor 12; as shown in FIG. 5, the second trigger event can synchronously integrate the fifth frame of the upper optical navigation sensor 16 with the second frame of the lower optical navigation sensor 16. That is, the operation processor 12 can integrate the displacement data of the plurality of optical navigation sensors 16, and synchronously process the tracking trajectory generated by the different optical navigation sensors 16 to achieve the displacement synchronization function.

In addition, the plurality of optical navigation sensors 16 may have different frame rates or different phase difference; as shown in FIG. 5, the second trigger event has a time difference between the fifth frame of the upper optical navigation sensor 16 and the second frame of the lower optical navigation sensor 16, and the present invention can further define that the detection data can include time duration or a frame count of all frames generated by the tracking module 18 in response to the object tracking process. When the plurality of optical navigation sensors 16 receives the trigger event and the detection data are synchronously updated to the readout buffer 22 for alternately transmitting to the operation processor 12, the operation processor 12 can analyze the time duration and/or the frame count of all frames of the plurality of optical navigation sensors 16, and compensate difference in the frame rate or in the phase about the plurality of optical navigation sensors 16 based on the foresaid analysis result, which means the time difference between the foresaid different frames can be compensated, so as to further optimize the displacement synchronization function.

Besides, the detection data of the present invention can further include a tracking confidence level generated by the tracking module 18 in response to the object tracking process. The tracking confidence level can be interpreted as a difference between a predicted trajectory and a tracking trajectory generated by the object tracking process. For example, the historical trajectory can be an arc line from left to right, and therefore the predicted trajectory can usually be the arc line from left to right; if the tracking trajectory is a straight line from left to right, the detected trajectory is abnormal, and the difference between the tracking trajectory and the predicted trajectory can be converted into the tracking confidence level. The foresaid difference can be inversely proportional to the tracking confidence level; that is, the smaller the foresaid difference, the higher the tracking confidence level. The detection data with the higher tracking confidence level can be retained, and the detection data with the lower tracking confidence level may reduce the weight or be directly discarded, so as to avoid a final displacement detection result of the optical navigation system 10 from being inaccurate due to the abnormal trajectory.

Moreover, the tracking confidence level may be interpreted as a feature matching result of several frames generated in the object tracking process. For example, the object tracking process may at least generate a previous frame and a following frame. A plurality of feature points inside the previous frame can be set as a first cluster, and the plurality of feature points inside the following frame can be set as a second cluster. If distribution parameters of some feature points in the first cluster are different from its distribution parameters in the second cluster, a matching result can be computed in accordance with a distribution ratio of the feature points in different clusters of different frames, and then further converted into the tracking confidence level. Generally, the tracking confidence level converted by the matching result can be higher in response to high distribution similarity of the feature points in the corresponding cluster of different frames. Manners of computing the tracking confidence level are not limited to the foresaid embodiments, and depend on the design demand.

The optical navigation system 10 can compare the tracking confidence levels of the plurality of optical navigation sensors 16 with a preset threshold range; an actual value of the preset threshold range can be set in accordance with accuracy of the optical navigation sensor 16 and computation efficiency of the operation processor 12, and a detailed description is omitted herein for simplicity. If the tracking confidence level of one optical navigation sensor 16 is higher than the preset threshold range, the detection data acquired by the foresaid optical navigation sensor 16 can have the higher weight; if the tracking confidence level of another optical navigation sensor 16 is within the preset threshold range, the detection data acquired by the foresaid optical navigation sensor 16 can have the lower weight; if the tracking confidence level of other optical navigation sensor 16 is lower the preset threshold range, the detection data acquired by the foresaid optical navigation sensor 16 can be discarded. Therefore, the optical navigation system 10 can set a weight ratio among the plurality of optical navigation sensors 16, and utilize the weight ratio to determine reliability of the detection data acquired by the plurality of optical navigation sensors 16, so as to decide whether the optical navigation sensor 16 has abnormal detection and whether to apply or discard the detection data.

In conclusion, the optical navigation system of the present invention can design the communication interface with specific definition among the operation processor and the optical navigation sensors. The communication interface may be the GPIO interface for transmitting the pulse signal or the I2C interface for transmitting the bus command. The optical navigation sensor can additionally include the decoder and the accumulated buffer; the accumulated buffer can store the detection data of the tracking module before synchronously updating process, and the decoder can receive the trigger event for synchronously updating the detection data from the accumulated buffer to the readout buffer. The detection data can include, but not be limited to, the displacement data, the time duration and/or the frame count of the frames, and the tracking confidence level. The present invention can synchronize the displacement data of the plurality of optical navigation sensors, and further compensate the displacement data by the time duration and/or the frame count of the frames and the tracking confidence level, so that the operation processor can calibrate the difference in the frame rate, the phase and the tracking confidence level among the plurality of optical navigation sensors, for providing the preferred displacement synchronization function.

In product application, the optical navigation system of the present invention can dispose the plurality of optical navigation sensors respectively on different positions of the transportation tool, such as the position near by a front wheel and a rear wheel on the left side of the vehicle, and the position near by the front wheel and the rear wheel on the right side of the vehicle. The plurality of optical navigation sensors can transmit the displacement data generated in the object tracking process to the operation processor, and the operation processor can integrate the displacement data via the foresaid displacement synchronization function, so as to accurately decide the behavior (such as moving forward, moving backward, and turning) of the vehicle; optionally, the time duration and/or the frame count of the frames and the tracking confidence level can be optionally applied to calibrate the synchronously integrated result of the displacement data and/or discard the abnormal frame, so the accuracy of the displacement synchronization function can be improved accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical navigation sensor applied for an operation processor with a displacement synchronization function, the optical navigation sensor comprising:
a tracking module adapted to generate detection data;
a decoder adapted to receive a trigger event;
a readout buffer connected to the operation processor via a communication interface; and
an accumulated buffer connected to the tracking module, the decoder and the readout buffer, the accumulated buffer being adapted to store the detection data from the tracking module, and further to immediately update the detection data to the readout buffer when the decoder receives the trigger event, so as to transmit the detection data from the readout buffer to the operation processor through the communication interface.

2. The optical navigation sensor of claim 1, wherein the detection data inside the accumulated buffer is deleted when the decoder receives the trigger event and the detection data is updated to the readout buffer.

3. The optical navigation sensor of claim 1, wherein the detection data generated by the tracking module is accumulated and stored inside the accumulated buffer during a time period of the decoder not receiving the trigger event.

4. The optical navigation sensor of claim 1, wherein the detection data is displacement data generated by the tracking module in object tracking process.

5. The optical navigation sensor of claim 1, wherein the detection data is time duration or a frame count of all frames generated by the tracking module in object tracking process.

6. The optical navigation sensor of claim 1, wherein the detection data is a tracking confidence level generated by the tracking module in object tracking process.

7. The optical navigation sensor of claim 6, wherein the optical navigation sensor analyzes a feature matching result of several frames generated by the tracking module in the object tracking process for converting into the tracking confidence level.

8. The optical navigation sensor of claim 6, wherein the optical navigation sensor analyzes a difference between a predicted trajectory and a tracking trajectory generated by the tracking module in the object tracking process for converting into the tracking confidence level.

9. An optical navigation system with a displacement synchronization function, comprising:
an operation processor adapted to output a trigger event;
an communication interface; and
a plurality of optical navigation sensors electrically connected with the operation processor via the communication interface, each of the plurality of optical navigation sensors comprising:
a tracking module adapted to generate detection data;
a decoder adapted to receive the trigger event;
a readout buffer connected to the communication interface; and
an accumulated buffer connected to the tracking module, the decoder and the readout buffer, and adapted to store the detection data from the tracking module;
wherein the plurality of optical navigation sensors is adapted to synchronously update the detection data from a plurality of accumulated buffers to corresponding readout buffers when the decoder receives the trigger event, so as to alternately transmit the detection data from the readout buffers to the operation processor through the communication interface.

10. The optical navigation system of claim 9, wherein the operation processor is electrically connected with the plurality of optical navigation sensors via the one-to-many communication interface, or is electrically connected with the plurality of optical navigation sensors via the many-to-many communication interface.

11. The optical navigation system of claim 9, wherein the detection data inside the accumulated buffer is deleted when the decoder receives the trigger event and the detection data is updated to the readout buffer.

12. The optical navigation system of claim 9, wherein the detection data generated by the tracking module is accumulated and stored inside the accumulated buffer during a time period of the decoder not receiving the trigger event.

13. The optical navigation system of claim 9, wherein the detection data is displacement data generated by the tracking module in object tracking process.

14. The optical navigation system of claim 13, wherein the displacement data of the plurality of optical navigation sensors is integrated by the operation processor to synchronously process tracking trajectories respectively generated by the plurality of optical navigation sensors.

15. The optical navigation system of claim 9, wherein the detection data is time duration or a frame count of all frames generated by the tracking module in object tracking process.

16. The optical navigation system of claim 15, wherein the operation processor analyzes the time duration or the frame count of the plurality of optical navigation sensors to compensate a frame rate difference or a phase difference between the plurality of optical navigation sensors.

17. The optical navigation system of claim 9, wherein the detection data is a tracking confidence level generated by the tracking module in object tracking process.

18. The optical navigation system of claim 17, wherein the operation processor compares tracking confidence levels of the plurality of optical navigation sensors with a preset threshold range, and sets a weight ratio about the plurality of optical navigation sensors in accordance with a comparison result.

19. The optical navigation system of claim 17, wherein the optical navigation sensor analyzes a feature matching result of several frames generated by the tracking module in the object tracking process for converting into the tracking confidence level.

20. The optical navigation system of claim 17, wherein the optical navigation sensor analyzes a difference between a predicted trajectory and a tracking trajectory generated by the tracking module in the object tracking process for converting into the tracking confidence level.
